(19) United States
(12) Patent Application Publication
(10) Pub. No.: US 2012/0059983 A1
(43) Pub. Date: Mar. 8, 2012

(54) PREDICTOR-BASED MANAGEMENT OF DRAM ROW-BUFFERS

(76) Inventors: David Wilkins Nellans, Salt Lake City, UT (US); Manu Awasthi, Salt Lake City, UT (US); Rajeev Balasubramonian, Sandy, UT (US); Alan Lynn Davis, Coalville, UT (US)

(21) Appl. No.: 12/875,314

(22) Filed: Sep. 3, 2010

(51) Int. Cl. G06F 12/00

(52) U.S. Cl. 711/105; 711/154; 711/E12.001

(57) ABSTRACT

A method for managing memory includes storing a history of accesses to a memory page, and determining whether to keep the memory page open or to close the memory page based on the stored history. A memory system includes a plurality of memory cells arranged in rows and columns, a row buffer, and a memory controller configured to manage the row buffer at a per-page level using a history-based predictor. A non-transitory computer readable medium is also provided containing instructions therein, wherein the instructions include storing an access history of a memory page in a lookup table, and determining an optimal closing policy for the memory page based on the stored histories. The histories can include access numbers or access durations.

### STATEMENT OF GOVERNMENT INTEREST

This invention was made with government support under CCF0916436 awarded by National Science Foundation. The Government has certain rights in this invention.

### FIELD

The present disclosure is directed to computer memory systems, particularly dynamic random access memory (DRAM), and methods of using same.

### BACKGROUND

DRAM Operation

A DRAM chip (or device) can be organized as a collection of 2D arrays of 1-bit memory cells which are often called sub-arrays or mats. Multiple mats are grouped together to form “banks.” Each bank has a single row-buffer associated with it to store the last row or “page” that was read from that bank. A page stored in the row-buffer can be referred to as a DRAM-page, to avoid confusion with a virtual/physical page used by the operating system. A Dual In-line Memory Module (DIMM) package typically includes 8 or 9 DRAM chips. Most DRAM data entities (row-buffers, DRAM-pages, cache lines) are striped across all of these chips.

A DRAM memory cell can include a transistor coupled to a capacitor, and the presence or absence of charge on the capacitor represents a data bit. Due to the leakage of the capacitor, DRAM needs refresh cycles in addition to normal read and write access cycles. In a row access cycle (page opening), a row is selected and the content of which is transferred into the row buffer. The content in the accessed row is erased. In a PRECHARGE cycle (page closing), the content of the row buffer is transferred back to the memory array to replace the erased content.

For an asynchronous DRAM, a clock input is not needed, and rows and columns are accessed through a row address strobe (RAS) and a column address strobe (CAS), respectively. For a synchronous DRAM (SDRAM), a clock input is used, and the timing delays are specified with respect to this clock. An SDRAM uses a sequence of commands synchronously to open a page, access a column, and close the page.

Computer systems often employ a cache that holds a subset of the contents of the memory for faster access. Cache is similar to buffer to some extent, but is intended to reduce accesses to underlying, slower, storage by storing data blocks that are likely to be read multiple times.

The basic operation of DRAM can be as follows. To read/write a cache line, the memory controller first issues the row-activation command—RAS to the DIMM. This selects the appropriate bank and activates the appropriate wordline in that bank. The corresponding row (DRAM-page) is then read (opened) into a set of sense amps (plus latches) referred to as the row-buffer. The row-buffer can be, for example, four or eight kilobytes in size, many times the size of a single last level cache line for which memory controllers and bus protocols are optimized. Any read or write operations then take place within the data present in the row-buffer with the CAS command that identifies a specific cache line within the row-buffer. Once the load/store operations are complete, the DRAM-page is closed and data is written back to the memory cells, using the explicit PRECHARGE command, rendering the row-buffer empty.

Because the appropriate DRAM-page is typically brought into the row-buffer before any reads/writes can occur, there is the potential for having the wrong DRAM-page open in the DRAM device. If there is already a DRAM-page open from a previous read/write operation, and the current requested line is in the same DRAM page, the operation is an open-page hit or row-buffer hit. If the request refers to a different DRAM-page in the same bank, the previously opened DRAM-page has to be closed before the new requested DRAM-page can be brought down into the row-buffer. Such a scenario constitutes a page-conflict, sometimes also called a row-buffer miss. In a potential third case, where there is no open DRAM-page in the bank, the operation is called an empty-page access. Table 1 shows that in DDR3-1333 (800 MHz) operations for a CPU running at 3.0 GHz, hits to an open DRAM-page have a 2-3× latency advantage over empty-page accesses or page-conflicted requests, for accessing DRAM devices, without considering other system overheads such as queuing and bus arbitration delays. Additionally, row-buffer hits are also the most power-efficient way to read/write data from a DRAM, because the cost of one-time ACT and PRECHARGE operations can be amortized over multiple reads/writes.

TABLE 1

| | Minimum Latency | Energy |
|---|---|---|
| Operation | in CPU Cycles | Consumption (nJ) |
| RCD (ACT + RAS) | 45 | 20.711 |
| CAS | 45 | 1.142 |
| PRECHARGE | 45 | 19.281 |
| Open-Page Hit | 45 | 1.142 |
| Empty-Page Access | 90 | 21.853 |
| Page-Conflict | 135 | 41.134 |

Row-Buffer Management Policies

The amount of time a DRAM-page is kept open in the row-buffer determines the row-buffer management policy of the DRAM device. In an open-page policy, after the initial request is serviced, the DRAM-page is kept open until it must be closed due to a page conflict. The intuition behind this long-standing policy is that applications are expected to have sufficient DRAM locality so that keeping DRAM-pages open decreases latency for the upcoming accesses to the same row-buffer. In a closed-page policy, data are written back to the memory array as soon as the initial operation completes. If the next request to the bank is expected to be to a different DRAM-page, this early write-back of data reduces latency for the next request. By closing the DRAM-page immediately, the risk of expensive page-conflicts is reduced. However, the possibility of open-page hits is also eliminated.

Further descriptions of DRAM operations can be found, for example, in U.S. Pat. Nos. 6,389,514, 6,604,186, and 6,799,241, the disclosures of which are incorporated herein by reference in their entirety.

### SUMMARY

In one aspect, a method is provided including storing a history of accesses to a memory page, and determining whether to keep the memory page open or to close the memory page based on stored history.

In one embodiment, said storing a history comprises storing a number of accesses to the memory page. The method can further include closing the memory page after the number of accesses has reached a predetermined value that is adjustable based on the stored history.

In one embodiment, the method further includes predicting when the memory page should be closed for an optimal system throughput based on the stored history, and closing the memory page based on the prediction.

The storing a history can comprise storing a duration for which the memory page is kept open. The method can further include closing the memory page after the memory page has been open for a predetermined duration. The duration can be characterized by the number of cycles, for example.

In another embodiment, the method further includes closing the memory page based on the number of accesses to the memory page, the duration of the memory page to be open, or a page conflict, and updating the stored history. The closure of the memory page can be based upon a page conflict, and wherein the updating the stored history includes decrementing the stored number of accesses. The stored number of accesses is decremented by 1 for each page conflict.

In some embodiments, the method can further include dynamically adjusting a closing policy for the memory page based on the stored history. The determination of whether to keep the memory page open or to close the memory page can be performed without a timer, and can be based on the trend of accesses in the stored history.

In one embodiment, the method further includes optimizing a row-buffer management policy by selecting a hybrid policy among a plurality of policies ranging between an open-page policy and a closed-page policy. The row-buffer management policy is at a per page level.

In another aspect, a system is provided including a plurality of memory cells arranged in rows and columns, a row buffer, and a memory controller configured to manage the row buffer at a per-page level using a history-based predictor.

In one embodiment, the history-based predictor includes an access-based predictor. In another embodiment, the history-based predictor includes a time-based predictor.

In some embodiments, the memory controller does not manage the row buffer based on a timer. The system can be a multi-core system.

In another aspect, a non-transitory computer readable medium is provided containing instructions therein, wherein the instructions include storing an access history of a memory page in a lookup table, and determining an optimal closing policy for the memory page based on the stored histories.

In one embodiment, the access history includes access numbers. In another embodiment, the access history includes an access duration. The access duration is measured by a number of cycles.

### BRIEF DESCRIPTION OF THE DRAWINGS

FIG. 1 is a schematic diagram illustrating optimizing hybrid DRAM-page policies according to one representative embodiment.

FIG. 2 is a histogram illustrating scaling of row-buffer hit rates for multi-threaded workloads as measured on actual machines.

FIGS. 3a and 3b are histograms illustrating workload performance, in simulation studies, under open-page, closed-page, and single-timer-based row-buffer management policies for single core systems and 8 cores/8 threads systems, respectively.

FIGS. 4a and 4b are plots illustrating variations in DRAM row-buffer hit rates, in simulation studies, using an open-page management policy for 8 core/8 thread workloads for all DRAM-pages accessed, and per bank, respectively.

FIGS. 5a and 5b are plots illustrating accuracy of per DRAM-page-based predictors, in simulation studies, for time-based predictor (TBP), and access-based predictor (ABP), respectively.

FIGS. 6a and 6b are plots illustrating performance results, in simulation studies, for workloads when using different policies including TBP- and ABP-based predictions for a single core system, and an eight-core/eight-thread system, respectively.

FIGS. 7a and 7b are plots illustrating breakdown of DRAM-page accesses, in simulation studies, when using history-based predictions for TBP and ABP, respectively.

FIG. 8 is a histogram illustrating impact of hybrid row-buffer management on DRAM energy consumption in an eight-core/eight-thread system in simulation studies.

FIG. 9 is a block diagram illustrating a computer system employing DRAM-page policies in accordance with representative embodiments.

FIG. 10 is a flowchart illustrating the methods for controlling the DRAM memory in accordance with representative embodiments.

FIG. 11 is a schematic diagram illustrating an ABP scheme in accordance with a representative embodiment.

### DETAILED DESCRIPTION

Introduction

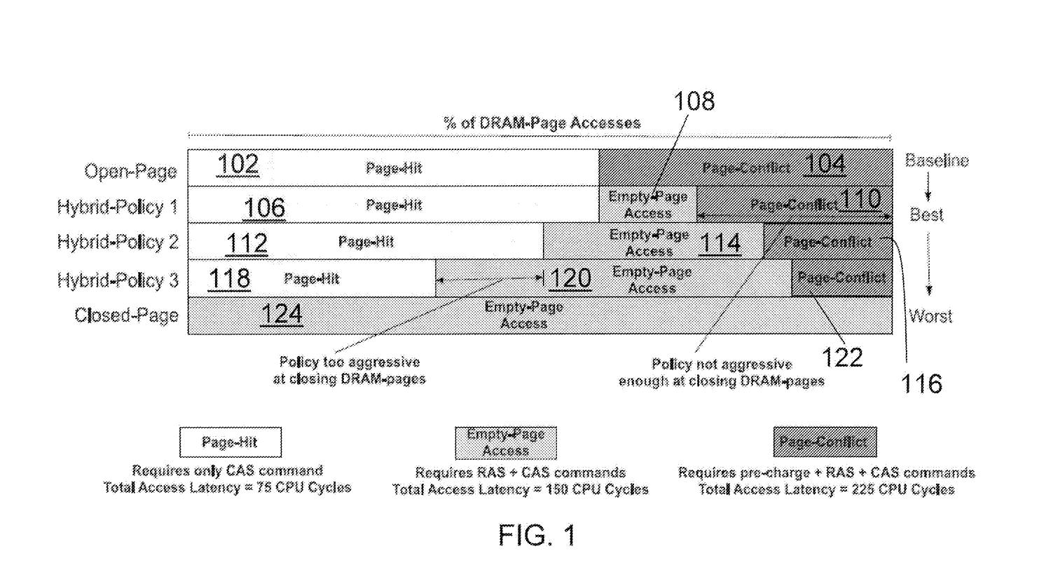

In one embodiment, a hybrid row-buffer policy is employed to have the benefits of both an open-page policy (high row-buffer hits) and a closed-page policy (low page-conflict). As shown in FIG. 1, hybrid row-buffer policies (which leave a DRAM-page open in the row-buffer, but not indefinitely) have the potential to achieve high row-buffer hit rates without incurring excess row-buffer conflicts. In contrast, the open-page policy has the highest percentage of page-hits and page-conflicts, while the closed-page policy only has empty page accesses. The goal of an effective hybrid policy is to convert page-conflicts into empty-page accesses without greatly diminishing the number of page-hits. The hybrid row-buffer policies in accordance with representative embodiments manage the row-buffer by storing a history of accesses to a DRAM-page, and determining whether to keep the page open or to close the page based on the stored history.

In an open-page policy, DRAM-page accesses include only page hits 102 and page conflicts 104. In a first hybrid policy, the DRAM page accesses include page hits 106, empty page accesses 108, and page conflicts 110. The page conflicts 110 may have a portion that is not optimal if the first hybrid policy is not sufficiently aggressive at closing DRAM pages. In a second hybrid policy, the DRAM page accesses include page hits 106, empty page accesses 108, and page conflicts 110. The second hybrid policy can have an optimal system throughput compared with other policies. In a third hybrid policy, the DRAM page accesses include page hits 118, empty page accesses 120, and page conflicts 122. The page conflicts 120 may have a portion that is larger than the optimal case if the third hybrid policy is too aggressive at closing DRAM pages. In a closed-page policy, DRAM-page accesses include only empty-page accesses 124.

In one embodiment, an optimal policy such as the second hybrid policy is obtained by iteratively or adaptively experimenting all possible policies, between the ranges of the “extreme” cases of open-page policies and closed-page policies, until the highest throughput configuration is identified, i.e., an optimal system throughput is reached.

An oracular (optimal) row-buffer management policy can maintain row-buffer hit rate of an open-page policy, while converting the highest number of page conflicts into empty-page accesses. However, in practice the longer a DRAM-page is left open (allowing hits), the higher the probability becomes for a page-conflict to occur. It is worth noting that row-buffer management policies alone may not increase the number of row-buffer hits beyond what is achieved by an open-page policy. However, any policy that is too aggressive at closing DRAM pages (such as a closed-page policy) can reduce the number of row-buffer hits.

Increased Randomness in Memory Streams

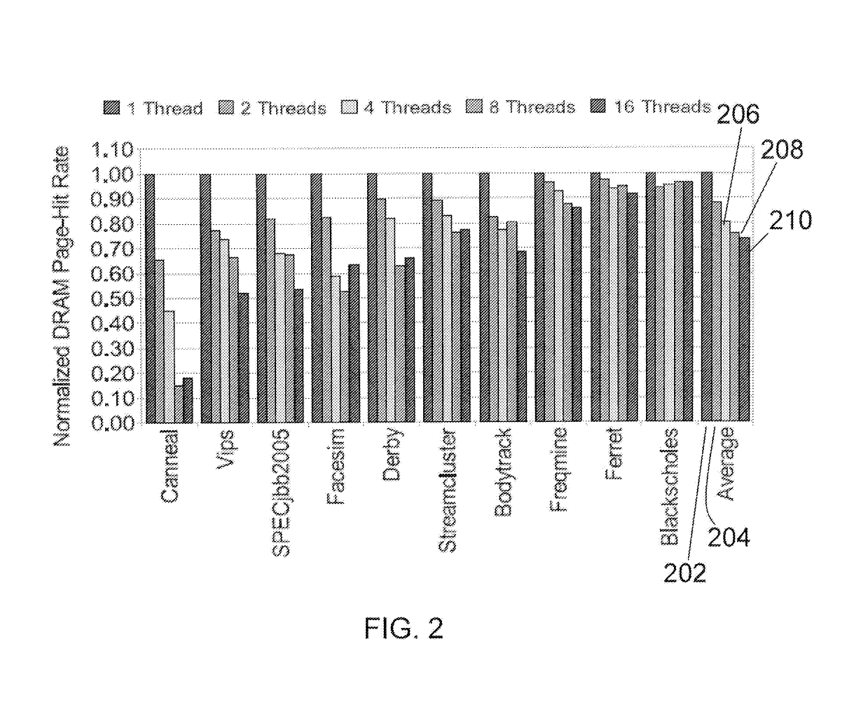

When running a small number of context-switched applications (such as in a uni-core system), sufficient locality exists in the memory access stream so that an open-page policy has traditionally been the policy of choice. As the number of cores sharing a memory system increases, accesses to DRAM can have reduced locality, rendering an open-page policy less successful in multi-core systems. In a working example, hardware performance counters are used to track the DRAM row-buffer hit rates using multi-threaded workloads, including PARSEC (with working set size “Native”), SPECjbb2005, and SPECjvm2005. Perfmon2 was used to collect statistics from the performance counters on a dual-socket, quad-core (2×4), AMD Opteron 2344HE based system with 32 GB of DDR2 RAM arranged as 16×2 GB DIMMs. System-wide DRAM access statistics are collected for benchmarks running one, two, four, eight, and sixteen threads each. All threads are pinned to distinct cores, except in the case of sixteen threads, where two threads exist per processor. Results are averaged across both on-chip memory controllers. FIG. 2 shows the percentage of DRAM accesses that are row-buffer hits for various applications and for the average. For each of the applications or the average, one, two, four, eight, and sixteen threads are represented with histograms such as 202, 204, 206, 208, and 210. As thread and core counts increase, row-buffer hit rates drop substantially for most applications.

To test the sensitivity of the eight-core/eight-thread workloads to memory latency (the primary metric impacted by row-buffer management policies), a simulation-based study is performed to vary a fixed memory latency across a wide variety of values for various benchmark programs. Average memory system latency changes of 200 cycles often result in 20+% changes in application throughput. Memory can be a frequent bottleneck, with application performance depending heavily on memory system latency. It should be noted that DRAM-device access time is only one portion of the total memory system delay. Queuing delays at the memory controller can dominate the total memory latency in multi-core systems, and any improvements in DRAM-device latency also can result in decreased queuing delays.

Some prior studies have focused on decreasing page-conflicts by striping data intelligently across DRAM devices. For example, a page-interleaving scheme can be provided where an XOR-based logic is used to distribute conflicting addresses to different banks, thereby decreasing page-conflicts. An RDRAM-specific, XOR-based method can also be provided to distribute blocks that map a given cache set evenly across DRAM banks, reducing buffer-sharing conflicts. The studies of memory controller scheduling policies to increase row-buffer hit rates include, for example, the FR-FCFS policy, where the memory controller prioritizes the issue of requests that will hit in currently-open rows. To address the needs of several threads in a multi-core processor, the Stall-Time Fair Memory (STFM) scheduler has been introduced in the literature. STFM stops prioritizing requests to open rows if other requests to non-open rows start experiencing long queuing delays. The Parallelism-Aware Batch Scheduler proposes breaking up requests into batches and scheduling batches (instead of single requests) at a time by exploiting bank-level parallelism within a thread. A history of recently scheduled memory operations can be kept to allow the scheduler to make better decisions and overcome memory controller bottlenecks.

A number of recent proposals have focused on various flavors of rank-subsetting schemes, for saving dynamic DRAM access energy. For example, the conventional DRAM rank can be broken into smaller entities (mini-ranks) to reduce the number of devices involved in a single memory access. Multi-core DIMM can be provided by grouping DRAM devices into multiple virtual memory devices, with a shared command bus, but each with its own data path. The method can be extended to design highly reliable systems. In some methods, short idle periods of DRAM activity can be coalesced into longer ones to extract the most out of DRAM low-power modes.

Predictors can be used for predicting dead cache blocks, identifying conflict misses, and prefetching new blocks to replace dead blocks. Energy can also be reduced by evicting dead blocks and placing regions of the cache into low-power modes.

Relatively few studies exist on dynamically switching row-buffer management strategies based on timers and threshold values in modern DRAM systems. One mechanism is to dynamically adjust the page-management policy based on memory access patterns. For example, the use of a per-bank threshold register can be introduced, which stores a pre-defined value (static or programmable, depending on the implementation). Once a page is opened, it is kept open until either (i) a timer exceeds the threshold, or (ii) there is a page-conflict. As an extension, locality can be rewarded by incrementing the threshold value by a fixed amount for every page hit. Page conflicts can also be decreased by keeping pages open in only a pre-determined number of banks (B) and closing the rest. The memory controller maintains a least recently used (LRU) stack of B currently open banks. If a new page needs to be opened, the row buffer in the LRU bank is closed as soon as all its pending operations are completed. In some scenarios, various pre-defined paging policies can be dynamically switched. In one example method, a row-buffer page conflict increments a counter, while an empty-page access that would have hit in the previously-opened page decrements that counter. For high counter values, the paging policy is made more aggressive, i.e., pages are closed sooner. The methods can be made more sophisticated by having different counters for each paging policy and using various events to update the counter and finally switch to more or less aggressive policies.

A threshold/timer-based mechanism can also be employed for row-buffer management. For example, the value of the threshold can be modified based on consecutive hits (misses) to a row-buffer. The amount by which the threshold value is increased (decreased) may be a constant, or may be increased exponentially. In some cases, only a subset of pages are allowed to be open. However, bank level optimization may not be sufficient. In a preferred embodiment, row buffers should be managed on a per DRAM-page level to be more effective.

Processors in the multi-core era are being designed for high throughput on multi-threaded workloads, while still supporting efficient execution of single-thread applications. Interleaved memory access streams from different threads reduce the spatial and temporal locality that is seen at the memory controller, making the combined stream appear increasingly random. Conventional methods for exploiting locality at the DRAM level, such as open-page access policies, become less effective as the number of threads accessing memory increases. DRAM memories in multi-core systems may see higher performance by employing a closed-page policy, but this eliminates any possibility of exploiting locality. DRAM systems can provide timers that close an open row after a fixed time interval, a compromise between the extremes of open- and closed-page policies. However, in modern computer systems, workloads exhibit sufficient diversity such that a single, or even multiple timers, may not adequately capture the variation that occurs between DRAM pages.

In one embodiment, a row buffer management policy is employed that closes an open page after it has been accessed (touched) N times. A hardware history-based predictor located within the memory controller can be used to estimate N for each DRAM page. In one working example, the access based predictor (ABP) improves system throughput by 18% and 28% over open- and closed-page policies, respectively, while increasing DRAM energy a modest 3.6% compared to open-page, and consuming 31.9% less energy than a closed-page policy. The predictor has a small storage overhead, for example, of 20 KB. The predictor is on a noncritical path for DRAM accesses, and does not require any changes to existing DRAM interfaces.

In the multi-core era, a single server may execute many threads of an application, many different programs, and even many different virtual machines. Memory can become a key performance bottleneck for modern multi-core systems, and DRAM energy can also be a major bottleneck, especially in data centers where it is projected to contribute, for example, 30% of total power. Each independent thread or process in a multi-core processor produces a stream of references that accesses a shared DRAM sub-system. While each of these streams may contain some spatio-temporal locality, these streams may be multiplexed into a single command stream at the memory controller. The result of this multiplexing is an increasingly random pattern of DRAM accesses.

This defeats various locality features in DRAM that have been highly effective in traditional single-core systems. One of these is the DRAM open-page policy. When the CPU requests a cache line, the DRAM chips read out an entire contiguous DRAM-page of data (typically 4 or 8 KB) from their arrays (mats) and save it to the row-buffer. If the CPU issues requests for neighboring cache lines, these are returned quickly by DRAM because the accesses can be serviced by the low latency row-buffer. If a request is made to a different DRAM page (a row-buffer conflict), a DRAM-page should be written back to the DRAM arrays before reading out the new DRAM-page into the row-buffer. This write-back delay is on the critical path and increases latency significantly for DRAM accesses which cause row-buffer conflicts.

To hide this latency, systems can adopt a closed-page policy where the open DRAM-page is written back to the DRAM arrays immediately after an access is serviced by the row-buffer. Closed-page policies have been inferior in most traditional systems because it is far more advantageous to optimize for row-buffer hits (and incur the cost of occasional row buffer conflict) than to optimize for row-buffer conflicts.

While the open-page policy has been a winner in terms of performance and energy in traditional single-core systems, it is inefficient in multi-core systems because of the increasingly randomized memory access stream. Representative embodiments of the disclosure provide a better solution between the two extremes of open-page and closed-page policies.

DRAM row-buffer management policies can be described as follows: a row-buffer is kept open for N cycles or until a row-buffer conflict, whichever happens first. N is zero for a closed-page policy, and infinity for an open-page policy, representing the two extremes. A policy that uses non-zero and non-infinite N is referred to as a hybrid row-buffer management policy. Modern DRAM memory controllers can integrate a global, per channel, or per bank timer, to allow the DRAM-page to be written back when the timer expires after N cycles. In some embodiments, active management of this timer is provided within the operating system, and can be exposed or made programmable, or actively controlled using performance feedback.

In a working example, a comprehensive analysis of open-page, closed-page, and timer-based row-buffer management policies is performed for modern multi-core systems. It can be shown that timer-based policy management is too coarse grained to be effective, even with per-bank timers. In accordance with an embodiment, the number of accesses to a DRAM-page is predicted, and the memory controller implements a history-based predictor to determine when a DRAM-page has seen all of its accesses and closes the DRAM-page after the last access. An access-based predictor (ABP) allows management of the row-buffer at the granularity of an individual DRAM-page, resulting in effective row-buffer management.

In a comparison example, a policy is evaluated where a timer value is predicted on a per DRAM-page basis, and is shown to be less effective compared with the ABP. By minimizing page-conflicts while maintaining a high row-buffer hit-rate, the throughput of an eight core chip multiprocessor can be improved, for example, by an average of 18% over open-page policy. In this example, the storage overhead of an effective predictor is only about 20 KB and it does not reside on the critical path of memory operations.

Methodology

To understand the impact of the row-buffer management policy on application throughput, modeling is performed for a complete multi-core processor, cache, and DRAM subsystem for an eight-core CMP for which all cores access main memory through a single memory controller. The simulator can be based on the Virtutech Simics platform, for example. The processor and cache hierarchy details for the simulations are listed in Table 2. The DRAM memory sub-system is modeled in detail using a modified version of Simics' trans-staller module. Out-of-order cores are simulated, which allow non-blocking load/store execution to support overlapped DRAM command processing. The memory scheduler implements FR-FCFS scheduling policy for open-page and hybrid schemes, and FCFS policy for closed-page scheme. DRAM address mapping parameters for the platform can be adopted from the DRAMsim framework. Basic SDRAM mapping, as found in user-upgradeable memory systems (similar to Intel 845G chipsets' DDR SDRAM mapping) can be implemented for an open-page policy, and an appropriate mapping for a closed-page policy.

TABLE 2
Core Parameters

| | | | |
|---|---|---|---|
| ISA | UltraSPARC III | CMP size | 4 or 8 cores/socket, |
| | ISA | | OoO cores |
| Re-Order- | 64 entry | Core Freq. | 3.0 GHz |
| Buffer | | | |
| L1 I- | 32 KB/2-way, | Fetch, Dispatch, | max. 4 per cycle |
| cache | private, 1-cycle | Execute, and Retire | |
| L2 Cache | 2 MB/8-way, | L1 D-cache | 32 KB/2-way, |
| | shared, 10-cycle | | private, 1-cycle |
| Coherence | MESI | L1 and L2 Cache | 64 Bytes |
| Protocol | | line size | |

DRAM Parameters

| | |
|---|---|
| DRAM Device | Micron MT47H128M8HQ DDR3-1333 Timing |
| Parameters | parameters, t_{CL} = t_{RCD} = t_{RP} = 15 ns (10-10-10 @ |
| | 800 MHz) 4 banks/DIMM, 16384 rows/bank, 512 |
| | columns/row, 32 bits/column, 8-bit output/device |
| DIMM | 8 Non-ECC un-buffered DIMMs, 1 rank/DIMM, 64 bit |
| Configuration | channel, 8 devices/DIMM |
| DIMM-level | 32 bits/column × 512 columns/row × 8 devices/ |
| Row-Buffer | DIMM = 8 KB/DIMM |
| Size | |
| Active row- | 4 (each bank in a device maintains a row-buffer) |
| buffers per | |
| DIMM | |
| Total DRAM | 512 MBit/device × 8 devices/DIMM × 8 DIMMs = 4 GB |
| Capacity | |
| Burst Size | 8 |

Timing details for on-chip caches and per-access DRAM energy numbers can be calculated using Cacti 6.5, the recent update to Cact±6.0 that integrates and improves on the DRAM specific features found in Cacti 5.0. DRAM memory timing details can be derived from the literature. For the experiments, the system can be warmed up for 100 million instructions and statistics can be collected over the next 500 million instructions.

Hybrid Row-Buffer Management

A simple hybrid row-buffer management policy can be one that closes an open DRAM-page after a configurable number of cycles N. If the currently-open DRAM-page is closed too aggressively (by setting N to a lower-than-optimal value), then accesses that would have been hits under open-page policy can be costly page-conflicts. Conversely, if the currently-open DRAM-page is left open too long (lazy closure), what would have been an empty-page access becomes a costly page-conflict. Both of these cases are shown in FIG. 1. The cost of being overly aggressive or too lazy with DRAM-page closure is substantial. For example, early DRAM-page closure always results in a 100% latency hit because an additional RAS command must now be re-issued before the next CAS. Compared to an optimal policy, lazy closure mechanisms cause a 50% latency premium for the next memory operation because the PRECHARGE command is now on the critical path compared to what would have been an RAS+CAS. Because of the higher performance penalty associated with premature row closures, it is preferred that hybrid row-buffer management schemes err on the side of safety (lazy closure).

In one embodiment, a method that uses performance feedback to choose between an open- and closed-page policy on a per application basis. The hybrid policies in accordance with representative embodiments can have the potential to increase performance beyond that of either policy used in isolation.

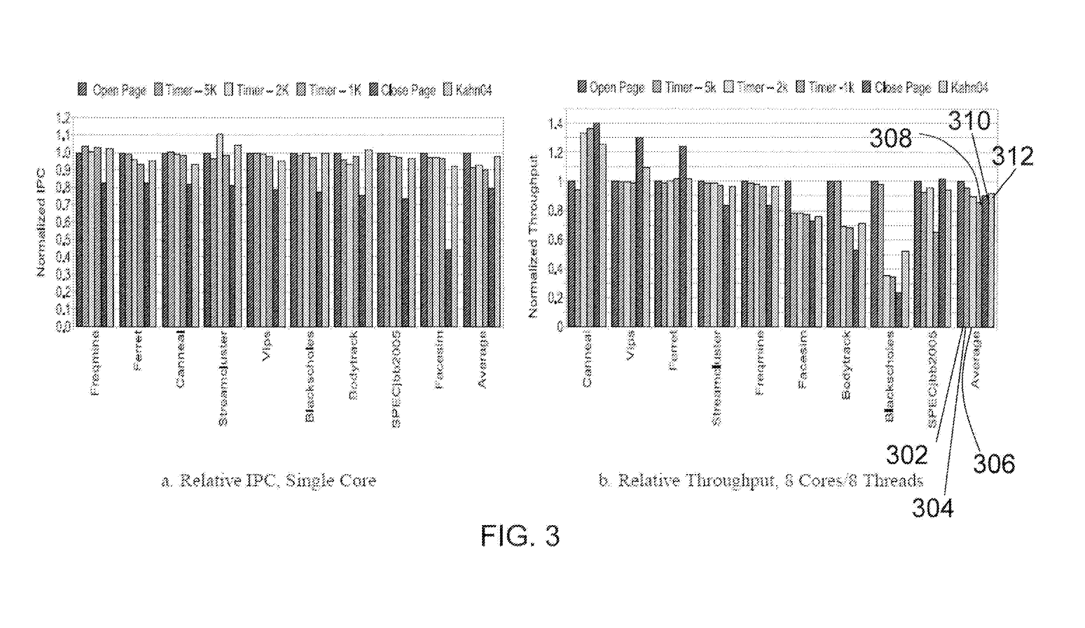

FIGS. 3a and 3b are histograms illustrating workload performance under open-page, closed-page, and single timer based row-buffer management policies for single core systems and 8 cores/8 threads systems, respectively. The histograms compare the open page policy 302, the timer—5 k policy 304, the timer—2 k policy 306, the timer—1 k policy 308, the closed-page policy 310, and the Kahn04 policy 312 (see below). Each of the timer—Nk policies refer to a row-buffer management strategy wherein a row-buffer is closed automatically after keeping it open for N cycles, or until a conflict occurs, whichever happens first.

For the eight-core/eight-thread workloads shown in FIG. 3b, a priori selecting the better of open- and closed-page policies for each individual workload would result in an average improvement of 9.5%.

Estimating the proper time N (N being the number of cycles for which to keep a row-buffer open) to use when programming a hybrid row-buffer policy is non-trivial. FIG. 3 shows application performance when using a hybrid policy based on static timer values. This simple hybrid policy keeps a row-buffer open until there is a conflict-miss or the timer value expires. Three timer values, 1 k, 2 k and 5 k, were chosen after empirically observing that the average duration between same-bank conflicts ranged from 1,940-2,838 cycles for an open-page policy across our benchmarks. The performance of these static-timer-based policies is lackluster, with average performance of 4-15% worse than the open-page policy.

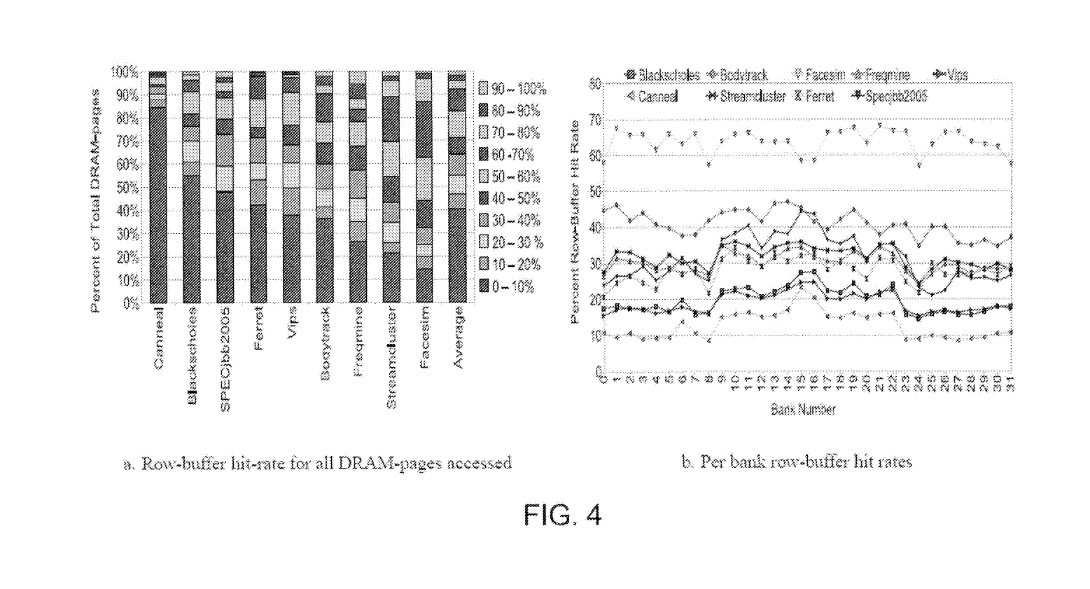

FIG. 4a shows that within a single application, the variation in row-buffer reuse can be very high. In addition, the variation in row-buffer reuse can be highly dependent on applications. This indicates that there is sufficient variation in row-buffer reuse rates such that a finer granularity hybrid policy in accordance with representative embodiments can improve on a hybrid policy using just a single global timer. The next granularity level for a timer-based hybrid policy can be using multiple timers, one per bank, for managing the row-buffer policy.

To test the viability of bank level tracking with multiple timers, a hybrid per-bank row buffer management policy described in U.S. Pat. No. 6,799,241 to Kahn et al. is implemented. The row-closure timer is set to, for example, N=750 cycles. Locality-rewarding is implemented by incrementing N by, for example, 150 every time there is a row-buffer hit. Kahn et al. do not describe a method for choosing these values. The values of 750 and 150 used here are based on the observation that the average row-buffer conflict in open-page occurs between 1,940-2,838 cycles (so a threshold significantly smaller than this is used as a starting point), and 150 cycles slightly exceed the average distance between row-buffer hits when they occur. FIGS. 3a and 3b show the performance of this per bank hybrid scheme for both the single-core and eight-core simulated machines, labeled as Kahn04. This hybrid scheme performs better than simple static timer based schemes. It also lowers the variation in throughput seen across benchmarks compared to closed-page policy. However, on average Kahn04 is unable to outperform an open-page policy in both single-core and eight-core configurations. The parameters used in Kahn04 are tuned, but it does not appear to substantially improve the average performance of this hybrid scheme using alternate values.

FIG. 4b shows the row-buffer hit rate across the banks within the memory subsystem, per application. In spite of the variability seen in FIG. 4a, there is a relatively small amount of variation between banks for a given application, most likely because logical OS-pages are typically allocated randomly across banks to distribute load. Low variation on a per-bank level indicates that hybrid policies that operate on a per-bank basis are unlikely to perform better than a single global hybrid policy. This is supported by the performance of Kahn04 seen in FIGS. 3a and 3b. Its attempt to compute an optimal “average” timer value per bank falls well short of capturing the diverse needs of individual DRAM-pages. High per-page variation, and low per-bank variation, provides the opportunity to do DRAM-page remapping (migration) to group high locality DRAM-pages within a single bank, and low locality DRAM-pages within another. By using DRAM-page migration, per-bank hybrid schemes may be more successful. However, co-locating hot DRAM-pages in the same bank may decrease their individual row-buffer hit rates, resulting in decreased system throughput. Moreover, mechanisms that rely on page migration may need to be avoided because of the migration overheads and associated book-keeping. As a result, managing row-buffer policies at per page lever is preferred over at a global, or per-bank level.

History-Based Row-Buffer Management

Because in multi-core systems there is likely to be too much locality variation between DRAM-pages, a single global timer, or multiple per-bank timers may not be effective. In accordance with representative embodiments, hybrid row-buffer management policies are implemented on a per DRAM-page basis to effectively leverage any available row-buffer locality. A history-based predictor is implemented in the memory controller that can do per DRAM-page tracking regarding row-buffer utilization and locality. This may require keeping track of a large or larger number of histories of, for example, 1,048,576 DRAM-pages, resulting in an overhead higher than implementing global or per-bank timer-based hybrid policies, the latter requiring one and 32 registers, respectively, for storage, along with associated logic. Thus, moving from a small number of timers, when implementing global (1) or per-bank (32) hybrid policies, to per DRAM-page (e.g., 1,048,576 for the system configuration used in the simulations) history tracking for the system results in a non-trivial amount of history overhead.

In an implementation of the history table, a 2048-entry/4 way cache CAN BE assumed. The cache is banked so the total entries are equally divided among DRAM banks (32 in the example case), effectively giving each DRAM bank its own 64-set 4 way cache. For fetching the predicted value, the page-id of the DRAM-page being accessed is used to index into the cache at the associated bank. In case of a cache miss, the least recently used (LRU) entry is replaced with that of the current one. A time-based predictor can use, for example, 16 bits for tag (page-id) and 16 bits for the predicted time value, making the total cache size 37.5 KB. The access-based predictor can use, for example, only 4 bits for storing the predicted value resulting in a 20 KB cache.

Based on Cacti 6.5 calculations using the parameters found in Table 2, a 32 KB, 4-way associative, 32-way banked cache has an access time of 1 cycle and consumes 2.64 pJ per access. Similarly, a 20 KB cache has an access time of 1 cycle and consumes 1.39 pJ per access. Compared to the DRAM access power (Table 1), the history cache lookup power is negligible. Look-ups to the predictor history table are not on the critical path as the prediction is required only after the DRAM-page has been opened (via an RAS) and read (via a CAS). This predictor history cache has an average hit-rate of 93.44%. Predictors that are better at capturing history may require more storage. At the extreme, a naive direct mapped cache that stores predictions for all DRAM-page indexes would provide 100% hit rate (excluding compulsory misses), but would require 512 KB-2 MB of storage.

Note that the predictor can be maintained on chip co-located with the memory controller. In addition to the predictor history table, a register value per bank can be used to hold the prediction and a small amount of circuitry can be used to decrement this register. Aside from the prediction history table, these hardware requirements can be substantially the same as those required by per-bank timers.

Per DRAM-Page Time-Based Prediction (TBP)

In accordance with some embodiments, hybrid row-buffer management schemes are employed to improve on open- or closed-page policies if they are able to adapt to the variation in row-buffer reuse that can occur within a bank. A time- or timer-based policy can be implemented to optimize the duration a DRAM-page is left open, shortening the time as much as possible until a DRAM-page is prematurely closed. The timer value can then be increased by a fairly large amount to help ensure that DRAM-pages are not overly aggressively closed, incurring both empty-page accesses and conflict misses, rather than an open-page hit.

For time-based predictions, the row-buffer closure policy can be implemented as follows: on a first access to a DRAM-page, the predicted duration threshold value is looked up in the history table. If no entry exists, the row-buffer is left open indefinitely until a page-conflict occurs. Upon closure, the duration the row-buffer was open is recorded in the history table for this DRAM-page. If an entry existed in the history table, the row-buffer is closed after the specified duration, or when a page-conflict occurs. If a page-conflict occurred, the history table entry is decremented by 25 (N−25). If the DRAM-page was closed via timer expiration, and a different DRAM page is opened on the next access, the prediction is deemed correct, but could possibly be better. Accordingly, the history table entry is decremented by 5 (N−5). If the DRAM-page was closed via the timer, and the same DRAM-page was brought back into the row-buffer on the next access, then the prediction is deemed bad (too short). Accordingly, the timer value is doubled (N*2). The history table will then be updated appropriately when the current DRAM-page is closed following the same algorithm. It is noted that other parameters, instead of the N−25, N−5, N*2 described above, can be used for updating the history table. The parameters can be selected from a design space exploration to achieve for the best performance for a given system.

Per DRAM-Page Access Based Prediction (ABP)

The hybrid row-buffer schemes described above have used time as their underlying method for determining when a row-buffer should be closed. Row-buffer hits are rewarded by extending the duration for which the DRAM-page is left open by the memory controller to exploit temporal locality. Because accesses to multiple banks are interleaved at the memory controller, it is possible for the same access pattern to a single row-buffer to have a different temporal profile when accessed multiple times through a workload's execution. As a result, temporal prediction is likely to be sub-optimal. To overcome this temporal variation, a row-buffer management policy is implemented that uses the number of accesses, rather than the duration in which those accesses occur, to predict when a DRAM-page should be closed. Perfect predictions have performance equivalent to an oracular closure policy. Closing the DRAM page immediately after a correct prediction results in the minimal possible performance conflicts and energy use. Contrast this to a timer-based policy, where a timer value N is predicated exactly across hundreds or thousands of cycles to obtain the same oracular performance.

For ABP, the row-buffer closure policy is implemented as follows: on a first access to a DRAM-page, the predicted number of accesses is looked up in the history table. If no entry exists, the row-buffer is left open until a page-conflict occurs. Upon closure, the number of accesses in the history table that occurred for this DRAM-page is recorded. If an entry exists in the table, the DRAM-page is closed after the specified number of accesses or when a page-conflict occurs. If a page-conflict occurs, the number of accesses in the history table can be decremented by 1. The updated history table can lead to an improved prediction the next time that DRAM page is accessed. If the DRAM-page is closed and a different DRAM-page is opened on the next access, the prediction is deemed acceptable and the value needs not be updated. If the same DRAM-page is brought back into the row-buffer, it is allowed to remain open until a page-conflict happens. At this point the history table is updated with the aggregate number of accesses so that premature closure is unlikely to happen again.

Experimental Results of Working Examples

Predictor Accuracy

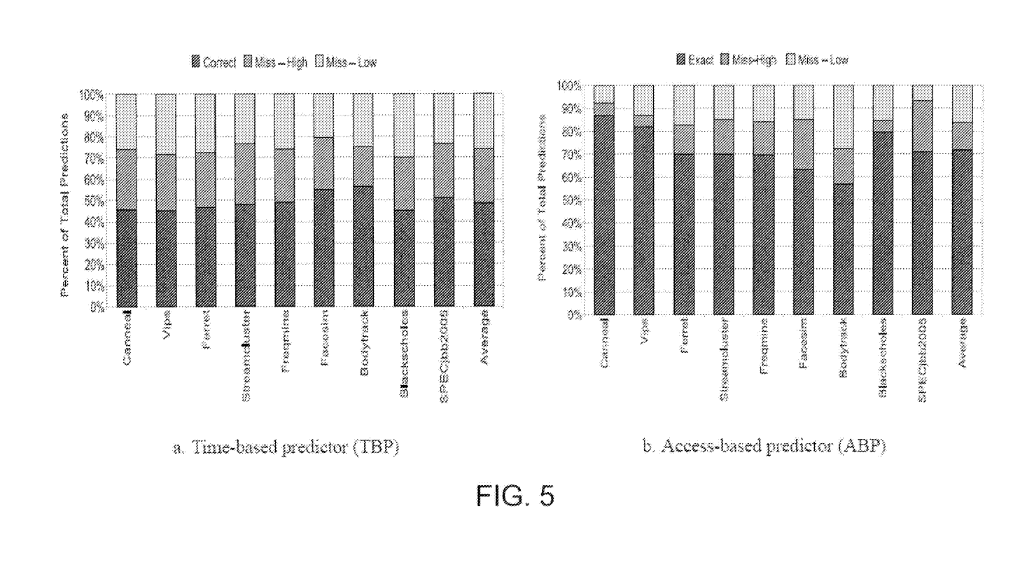

FIG. 5a shows the accuracy of TBP. “Correct” is the number of predictions made that resulted in neither a premature DRAM-page closure (resulting in subsequent re-opening) nor a page-conflict. On average, correct predictions were made 58.2% of the time. Correct predictions by definition result in only row-buffer hits. Of the mis-predictions, approximately half of them were too high, resulting in page-conflicts (equivalent to open-page policy). However, roughly half of the mis-predictions were too low, and would result in costly premature row-closures.

FIG. 5b shows the accuracy of ABP. Note that ABP makes exact predictions (when correct) and this may prove useful from the performance and power perspective. On average, ABP is able to predict the exact number of row-buffer accesses that will occur 72.5% of the time. This number indicates that DRAM-pages have extremely repetitive access patterns, though those patterns vary substantially between DRAM-pages (as seen in FIG. 4a). On average, the remaining 27.5% of row-buffer accesses are split roughly equally between misses that predicted too many or too few accesses. Compulsory or conflict misses for DRAM-pages for which a prediction does not exist in the prediction history table are calculated in this figure as Miss-High because the row-buffer is kept open until a page-conflict occurs. It may be advantageous to decrease the number of low-predictions (the most expensive miss prediction). It is noted that ABP may provide better performance than TBP; the high level of exact predictions indicates that access prediction will provide row-buffer hit rates very close to that of an open-page policy.

Application Throughput

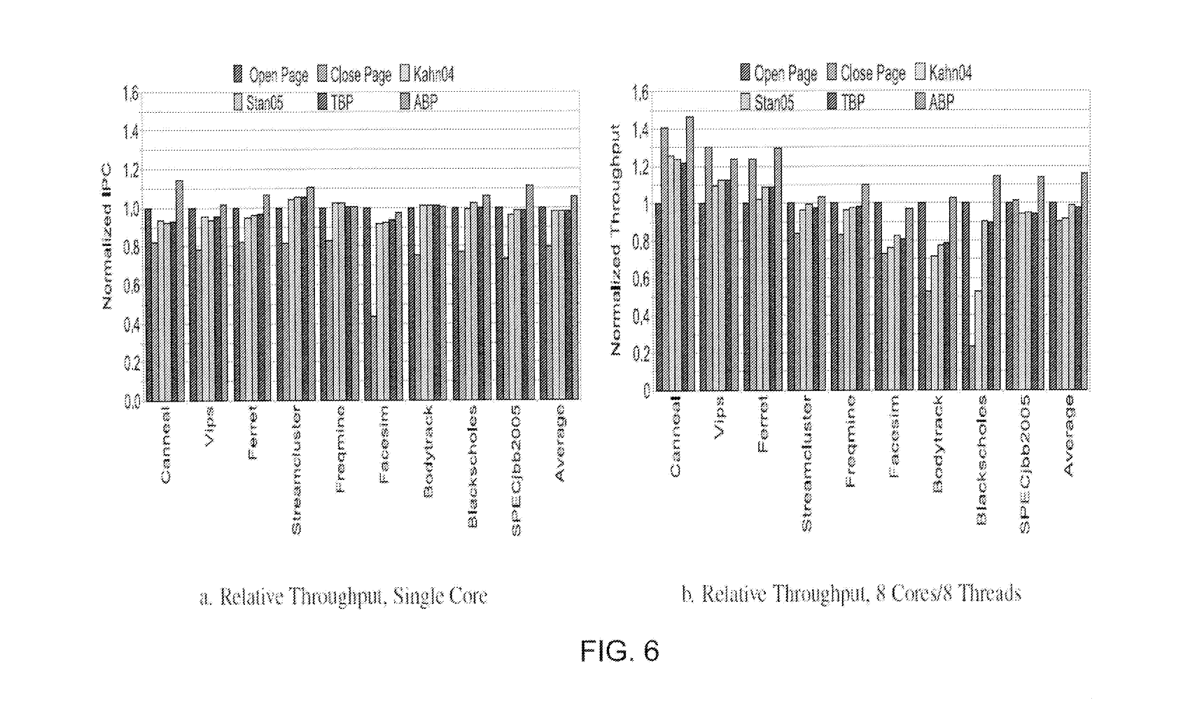

Results for the hybrid row-buffer management policies using ABP are shown in FIG. 6. On average, across all benchmarks, ABP has improved performance compared with other row-buffer management policies.

It is notable that ABP also outperforms a model (Stan05) adopting the use of prediction-based row-buffer management techniques, in which a prediction mechanism is based on a variation of a live time predictor. The prediction mechanism consists of two parts: a zero live time predictor and a dead time predictor. Every time a row-buffer is opened, the zero live time predictor (based on a 2 bit saturating counter) is used to predict whether the live time of this row would be zero. If so, the row is closed immediately after the current access (closed-page policy). If not, the second predictor is used to predict whether or not a row-buffer has entered its dead time. The predictor keeps track of time elapsed between the last two consecutive accesses to the row-buffer and closes it if there are no accesses to it during 4× this value, from the time of last access. Since the predictions are based on a notion of time, rather than number of accesses. Because the prediction is being made for each individual row buffer entry based on its current use, the prediction granularity is finer (per-DRAM page as opposed to per-bank).

ABP is able to outperform the implementation of Kahn04 and TBP across most of the benchmark suite for the eight-core/eight-thread configuration, and in seven out of nine benchmarks in the single-core configuration. Such improvements may result from both ABP and per-page based policy decisions to maximize the performance of any hybrid row-buffer management policy.

As mentioned above, one hybrid policy can use performance counters and dynamic feedbacks to choose either a static open-page or a closed-page policy on a per application basis. For the eight-core/eight-thread system, this system yields a 9.5% average improvement over a strictly open-page policy. In practice, sampling epochs may reduce these performance gains slightly. ABP provides an 18.1% improvement over an open-page policy, and thus an 8.6% improvement over a perfect dynamic selection of open- and closed-page policies.

In the comparison shown in FIG. 6, ABP provides a performance increase of 18%, 28%, 27%, 20%, and 17% over open-page, closed-page, Kahn04, TBP, and Stan05 management policies for eight-core/eight-thread workloads. Results are less dramatic but follow the same trend for single-core performances. ABP can outperform an open-page policy on average by 6.34%. For both single-core and eight-core/eight-thread cases, Stan05 performs better than Kahn04 and TBP, because of its higher prediction accuracy. However, it still fails to outperform ABP in either case. In addition to improving the performance, ABP provides significantly lower per-benchmark performance variations than a closed-page, Kahn04, or TBP policies. ABP may still underperform an open-page policy in the benchmark of Facesim, in both the eight-core and single-core configurations.

Row-Buffer Utilization

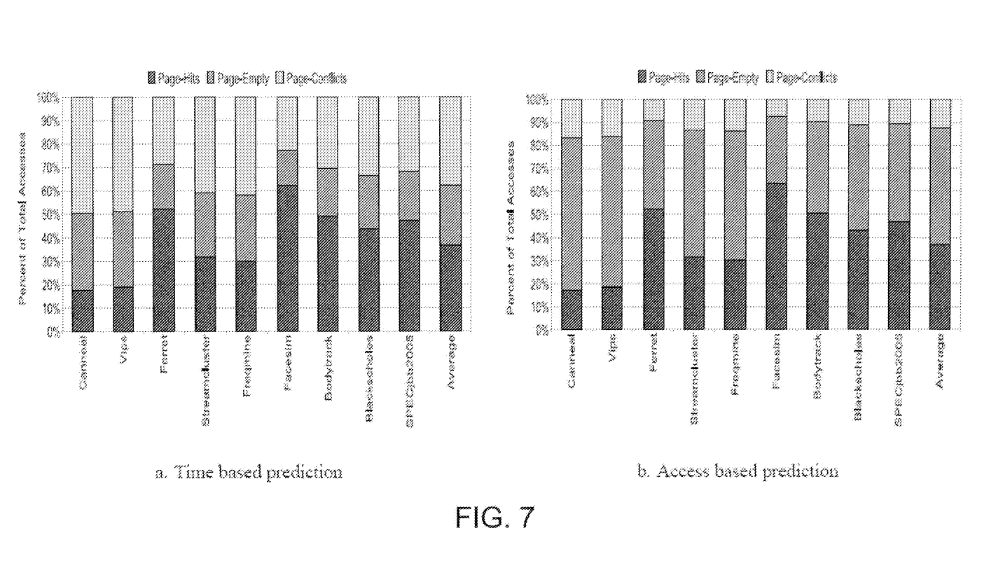

FIG. 7 shows the breakdown of DRAM-page accesses for TBP and ABP for the eight-core/eight-thread workloads. Both policies have an almost identical page-hit rate that is within 2% of the open-page policy row-buffer hit-rate for each application. The low variation in the page-hit rate indicates that neither TBP nor ABP suffers significantly from overly aggressive page closures. ABP shows a substantially higher ratio of empty-page accesses than TBP. Because empty page accesses are a lower-latency operation than page-conflicts, this improvement can provide a large portion of DRAM latency reduction seen when using ABP. For example, FIG. 7 shows that for the benchmark Canneal, ABP is able to convert 34% of DRAM-page accesses from page-conflicts to empty-page accesses with no reduction in page-hits. Two possible modifications that could improve the performance of ABP include using a larger prediction history table, or providing a global prediction for compulsory mis-predictions (first DRAM-page access). However, with only 13% of all DRAM-page accesses still resulting in page-conflicts, ABP has managed to bridge the majority of the gap between open page and optimal row-buffer management.

Sensitivity Analysis

The sensitivity of the proposed policies with respect to the size and associativity of the history table can be analyzed by experimenting with modifying the size of the table from the original size of 2048-set/4-way to half (1024), double (4096) and quadruple (8192) the number of sets. It is found that increasing capacity, while keeping associativity constant, increased the hit rates to 93.5% and 95.2%, respectively for 4096 and 8192 set/4-way table. This improvement in table hit rates translates into system throughput improvements of 2.1% and 2.7%, respectively for the eight-core/eight-thread case. Conversely, reducing the history table size causes a reduction in hit rate and system throughput. For the eight-core/eight-thread case, a 1024-set/4-way table (½ the original size) has a hit rate of 78.8% and reduces ABP's performance gains by 6.2%. However, using this smaller 1024-set/4-way table still yields an average overall throughput improvement of 12-22% compared to competing schemes in the eight-core/eight-thread case. To gauge the effect of higher associativity, eight-way history tables with 2048, 4096 and 8192 sets can also be tested. While the greater associativity helped improve history table hit rates, the system throughput improvement was at most 2.9% when compared to a similar sized 4-way table.

Power Impact of History-Based Row Buffer Closure

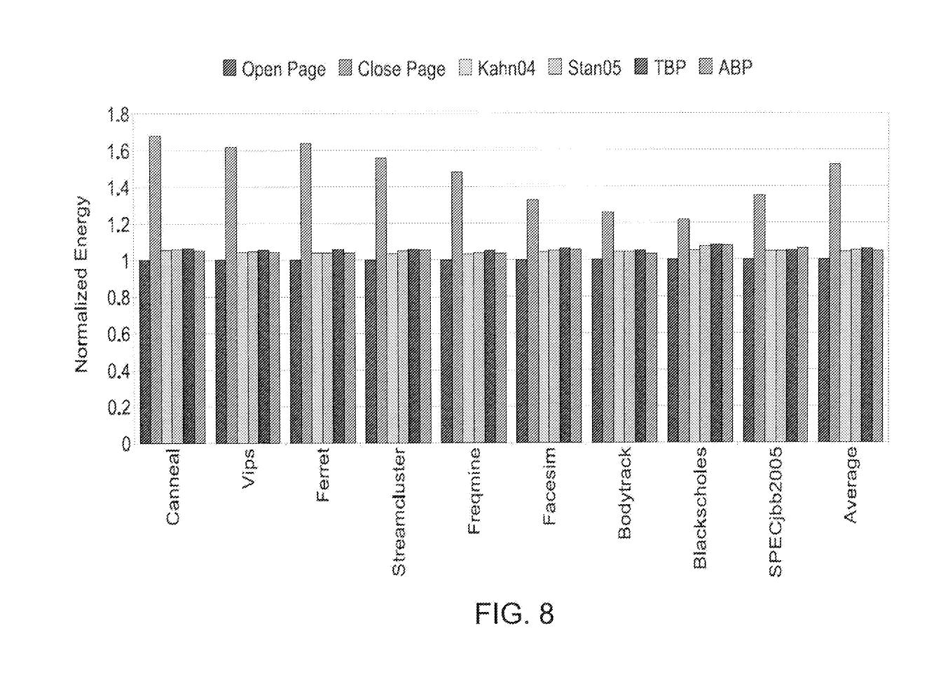

With DRAM power consumption becoming a larger fraction of total system energy, changes to the DRAM subsystem may not be made without understanding their implication on energy consumption. FIG. 8 shows the relative DRAM energy consumption required by different row-buffer management policies, normalized against an open-page policy. Note that Table 1 lists the energy consumed for RCD (ACT+RAS), CAS, and PRECHARGE operations. On average, the open-page policy can be the most energy frugal policy because it provides maximum opportunity for the expensive RCD and PRECHARGE operations to be amortized over row-buffer hits. Conversely the closed-page policy can be the least efficient policy because every access uses a fixed amount of energy including RCD+CAS+PRECHARGE. The hybrid policies in accordance with representative embodiments may consume just slightly more energy than an open-page policy, with ABP on average consuming 3.6% more than the open-page policy. Compared to the closed-page policy, ABP reduces energy consumption by 31.9%.

There is another potential energy advantage of ABP over the open-page policy. Once a row has been closed, the bank can be placed in a low-power state. Modern DRAM devices provide many low-power modes, and transitions can be made in and out of some of these modes with an overhead of just a handful of cycles. Exercising these low-power modes in tandem with ABP can lead to static energy reductions, relative to the open-page baseline.

Computer System

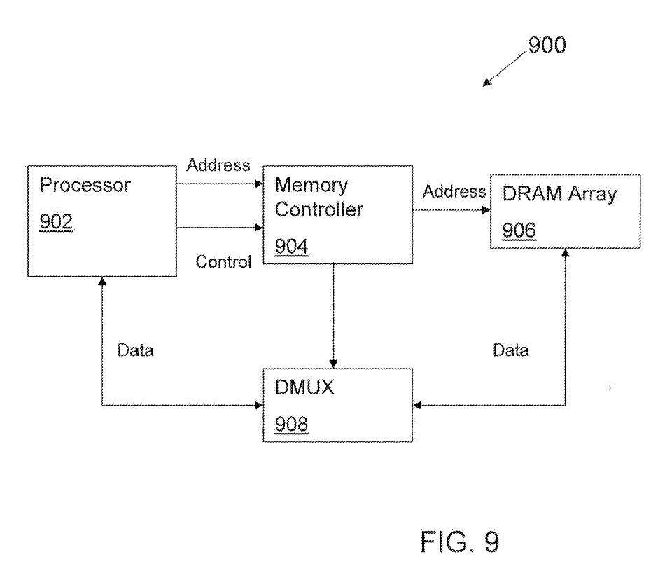

FIG. 9 is a block diagram illustrating a computer system 900 employing the row-buffer management policies described above. The computer system 900 includes a process 902, a memory controller 904, a DRAM memory array 906, and a data multiplexer (DMUX) 908. The memory controller 904 is responsible for the page control of the DRAM memory array 906, and implements the methods described above using either hardware or software approaches.

In a representative software implementation, the instructions for managing the DRAM memory array 906 can be stored in a computer readable medium such as a non-transitory computer readable medium. Examples of the computer-readable medium include a hard drive, a memory device, a compact disk, a flash memory drive, etc.

As described above, DRAM access patterns are becoming increasingly random as memory streams from multiple threads are multiplexed through a single memory system controller. The result of this randomization is that strictly open-page or closed-page policies are unlikely to be optimal.

A range of timer-based hybrid row buffer management policies are evaluated, and it is noted that an improvement on strictly open- or closed-page row-buffer management at the bank level may not be sufficient to maximize performance. Representative embodiments of the disclosure employ a row-buffer management strategy that can operate at the per-page level, providing a customized closure policy for every individual DRAM-page. In an example, using only 20 KB of storage, which is not on the critical path for memory operation latency, ABP is able to achieve an average throughput improvement of 18%, 28%, 27%, and 20% over open-page, closed-page, Kahn04, and TBP management policies for eight-core/eight-thread workloads. ABP provides improved performance and lower variation over other policies examined, and can outperform the open page policy on average by 6% in a uni-processor configuration. To achieve these performance gains, ABP uses, for example, on average only 3.6% more DRAM energy compared to an open-page policy, and consumes 31.9% less energy than a closed-page policy. Given the strong performance gains, low variability across workloads, and low energy consumption, ABP can replace the open-row policy in many-core systems or existing uni-processor designs.

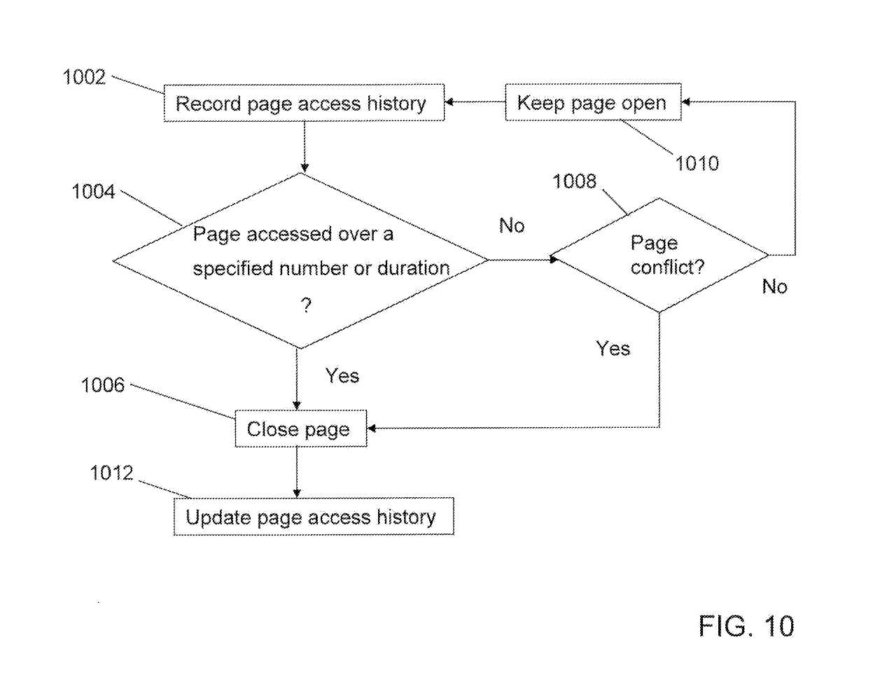

FIG. 10 is a flowchart illustrating a method for controlling the DRAM memory as described above. In step 1002, the page access history is stored. The history may be recorded in the form of a number of accesses to the memory page, or a duration that the memory page has been kept open. In step 1004, based on the stored history it is determined whether the memory page has been accessed for over a specified number or kept open for a specified duration. If so, in step 1006, the memory page is closed. Otherwise, in step 1008 if a page conflict occurs, the memory page is also closed. If there is no page conflict, the page is kept open in step 1010. After the page is closed in 1006, the page access history is updated. In particular, if the page is closed due to a page conflict, the page access history is adaptively adjusted to reduce the probability of future page conflict.

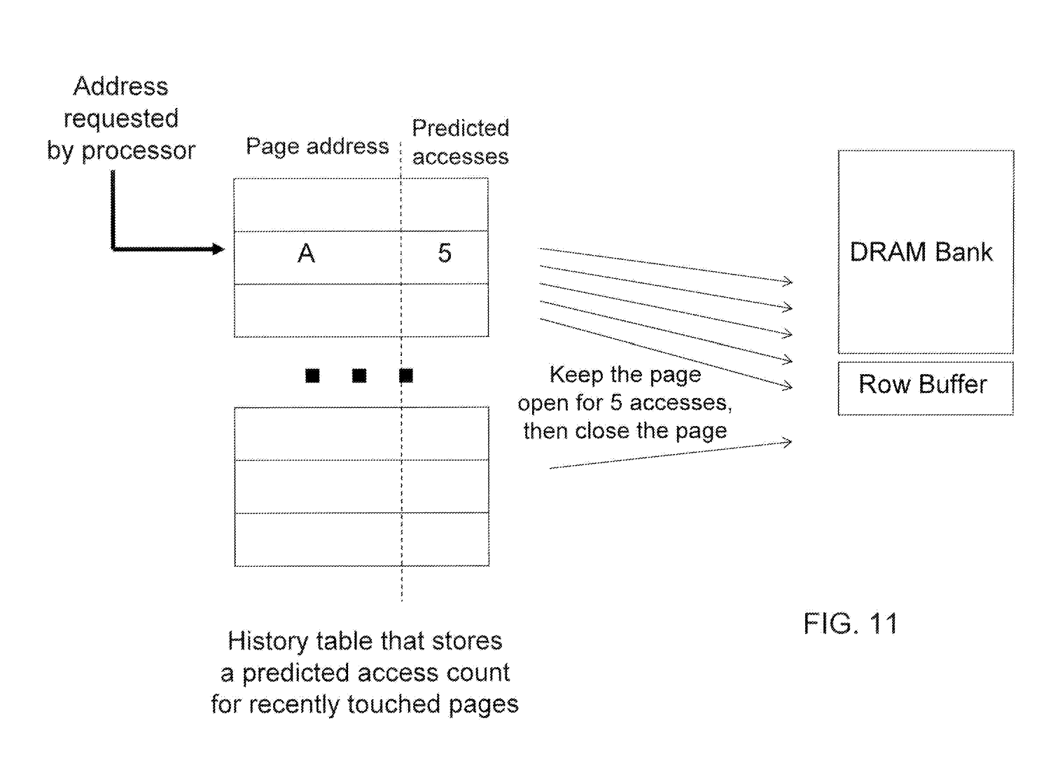

FIG. 11 is a schematic diagram illustrating an ABP scheme. As shown, the page addresses (e.g., “A”) and the predicted numbers (e.g., “5”) of accesses for each corresponding page can be stored in a table. The specific page “A” is kept open for 5 accesses, and then is closed. The history table is continuously updated during these operations to update the predicted access counts for recently touched pages.

Although the foregoing refers to particular preferred embodiments, it will be understood that the disclosure is not so limited. It will occur to those of ordinary skill in the art that various modifications may be made to the disclosed embodiments and that such modifications are intended to be within the scope of the disclosure. All of the publications, patent applications and patents cited herein are incorporated herein by reference in their entirety.

What is claimed is:

1. A method comprising:
storing a history of accesses to a memory page; and
determining whether to keep the memory page open or to close the memory page based on the stored history.

2. The method of claim 1, wherein said storing a history comprises storing a number of accesses to the memory page.

3. The method of claim 2, further comprising closing the memory page after the number of accesses has reached a predetermined value that is adjustable based on the stored history.

4. The method of claim 1, further comprising:
predicting when the memory page should be closed for an optimal system throughput based on the stored history; and
closing the memory page based on the prediction.

5. The method of claim 1, wherein said storing a history comprise storing a duration for which the memory page is kept open.

6. The method of claim 5, further comprising closing the memory page after the memory page has been open for a predetermined duration.

7. The method of claim 5, wherein the duration is characterized by a number of cycles.

8. The method of claim 1, further comprising:
closing the memory page based on a number of accesses to the memory page, a duration of the memory page to be open, or a page conflict; and
updating the stored history.

9. The method of claim 8, wherein said closing the memory page is based upon a page conflict, and wherein said updating the stored history comprises decrementing the stored number of accesses.

10. The method of claim 9, wherein the stored number of accesses is decremented by 1 for each page conflict.

11. The method of claim 1, further comprising dynamically adjusting a closing policy for the memory page based on the stored history.

12. The method of claim 1, wherein said determining is performed without a timer.

13. The method of claim 1, wherein the memory comprises a dynamic random access memory (DRAM).

14. The method of claim 1, wherein said determining is based on a trend of accesses in the stored history.

15. The method of claim 1, further comprising optimizing a row-buffer management policy by selecting a hybrid policy among a plurality of policies ranging between an open-page policy and a closed-page policy.

16. The method of claim 15, wherein the row-buffer management policy is at a per page level.

17. A system comprising:
a plurality of memory cells arranged in rows and columns;
a row buffer; and
a memory controller configured to manage the row buffer at a per-page level using a history-based predictor.

18. The system of claim 17, wherein the history-based predictor comprises an access-based predictor.

19. The system of claim 17, wherein the history-based predictor comprises a time-based predictor.

20. The system of claim 17, wherein the memory controller does not manage the row buffer based on a timer.

21. The system of claim 17, wherein the system is a multi-core system.

22. A non-transitory computer readable medium containing instructions therein, wherein the instructions comprise:
storing an access history of a memory page in a lookup table; and
determining an optimal closing policy for the memory page based on the stored histories.

23. The non-transitory computer readable medium of claim 22, wherein the access history comprises access numbers.

24. The non-transitory computer readable medium of claim 22, wherein the access history comprises an access duration.

25. The non-transitory computer readable medium of claim 24, wherein the access duration is measured by a number of cycles.
